(19) United States
(12) Patent Application Publication
(10) Pub. No.: US 2010/0197255 A1
(43) Pub. Date: Aug. 5, 2010

(54) Method and apparatus for dynamic station preset configuration in a radio

(75) Inventors: Shree Jaisimha, Senoia, GA (US); Hans A. Troemel, Sharpburg, GA (US); Gopalan Velayutham, Palatine, IL (US); Tatsuya Fujisawa, Atlanta, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 12/322,646

(22) Filed: Feb. 5, 2009

(51) Int. Cl. H04B 1/18

(52) U.S. Cl. 455/186.2

(57) ABSTRACT

A method of operating a radio having a plurality of station preset pushbuttons includes assigning to the preset pushbuttons a first group of radio frequencies associated with a first country. A spectrum of radio frequencies is scanned. A signal quality metric is measured for each of the scanned frequencies. A country of origin is determined for each of the scanned frequencies. A country in which the radio is disposed is ascertained dependent upon the measuring step and the determining step. If the country in which the radio is disposed is different from the first country, then either the preset pushbuttons are automatically re-assigned to a second group of radio frequencies associated with the country in which the radio is disposed, or a user is provided with an option to re-assign the preset pushbuttons to the second group of radio frequencies.

### BACKGROUND OF THE INVENTION

1. Field of the Invention

The present invention relates to radios for use in vehicles, and, more particularly, to determining a country in which a vehicle radio operates.

2. Description of the Related Art

Automotive manufacturers have begun to implement driver personalization within automotive entertainment systems and explore ways of differentiating their offerings to the end consumer. Manufacturers have already started coining terminologies such as Driver 1, Driver 2 and Chauffeur mode to entice the customer.

One aspect of automotive entertainment systems that may be personalized are preset pushbuttons, which are a staple option on radio head units. Sometimes referred to as “favorites” or “presets”, preset pushbuttons enable the vehicle occupant (i.e., driver and/or passenger) to store the frequencies of his favorite radio stations into nonvolatile memory so that the preset can be recalled at a later point in time instead of the user having to manually tune the radio to the desired station.

On a continent like Europe, where borderless travel is possible, the concept of having a fixed set of presets has its shortcomings. For example, a given set of presets may work in only one country. Known radio head units offer only a single level plane of presets for use per driver with no allowance for multiple countries. Known preset recall is non-intelligent and does not consider the country in which the vehicle is presently located.

Consider the example of a driver who stores presets in Germany and then drives to the United Kingdom where he does a preset recall. Because the vehicle is no longer in Germany, the preset recall triggers a non-intelligent search for the station that was stored. The radio eventually times out, concludes that the station does not exist, and clears the preset as per automotive original equipment manufacturer (OEM) requirements.

The main obstacle is the inability of the vehicle to recognize the country in which it is presently situated. While country determination is easily possible using global positioning system (GPS) technology, for low end radios with no navigation or GPS systems on board, this is not possible.

With car radios becoming more widely dispersed around the world, it is becoming more advantageous for the radios to detect characteristics of their environment and adjust internal settings of the radios accordingly. Currently, most digital AM/FM tuners utilize a fixed tuner sensitivity threshold for the Tuner Auto Seek operation, i.e., the operation wherein the tuner automatically scans across a frequency band until it comes to, and stops at, a frequency having a sufficiently strong signal. Most digital AM/FM tuners also utilize fixed parameters for other functions. The use of fixed tuner sensitivity thresholds and fixed parameters may result in audio quality that is uneven under different signal conditions. The fixed threshold and parameters values are typically defined within the calibration data according to region.

A radio convention or standard that differs between regions of the world is the use of Radio Data System (RDS) and Radio Broadcast Data System (RBDS). RDS is a standard from the European Broadcasting Union for sending small amounts of digital information using conventional FM radio broadcasts. The RDS system standardizes the transmission format of several types of information, such as the time of day and identification of the track, artist and radio station. RBDS is the United States' version of RDS. With regard to RDS/RBDS sensitivity, the radio typically requires a certain field strength sensitivity before RDS/RBDS synchronization can be achieved in order to receive Program Identification Code, Program Service Name, Alternate Frequency List and others which are defined in the RDS/RBDS standard protocol. The sensitivity may have dependencies on characteristics of the wireless environment including front-end filter bandwidth, field strength, multipath and adjacent channel interference to which the currently listened-to station is subjected.

Accordingly, what is neither anticipated nor obvious in view of the prior art is a method of modifying characteristics of vehicle electronics to take into account the country in which the vehicle is located.

### SUMMARY OF THE INVENTION

The present invention provides a method for personalizing a vehicle radio and establishing the radio's preset pushbuttons by considering the country in which the radio is located. The received radio signals are analyzed to determine the country in which the vehicle is situated, and the preset pushbuttons are programmed with desired frequencies accordingly.

The invention comprises, in one form thereof, a method of operating a radio having a plurality of station preset pushbuttons. A first group of radio frequencies associated with a first country are assigned to the preset pushbuttons. A spectrum of radio frequencies is scanned. A signal quality metric is measured for each of the scanned frequencies. A country of origin is determined for each of the scanned frequencies. A country in which the radio is disposed is ascertained dependent upon the measuring step and the determining step. If the country in which the radio is disposed is different from the first country, then either the preset pushbuttons are automatically re-assigned to a second group of radio frequencies associated with the country in which the radio is disposed, or a user is provided with an option to re-assign the preset pushbuttons to the second group of radio frequencies.

The invention comprises, in another form thereof, a method of operating electronics in a vehicle having a radio. A signal quality metric is measured for each of a plurality of radio frequencies. A country code carried in a transmitted signal for each of the radio frequencies is read. A country in which the vehicle is disposed is ascertained dependent upon the measuring step and the reading step. A characteristic of the electronics is modified based upon the country in which the vehicle is disposed.

The invention comprises, in yet another form thereof, a method of operating a radio having a plurality of station preset pushbuttons, including measuring a signal quality metric for each of a plurality of frequencies. A country code of a Radio Data System program identification is read for each of the frequencies. A country in which the radio is disposed is ascertained dependent upon the measuring step and the reading step. The preset pushbuttons are assigned to a group of radio frequencies associated with the country in which the radio is disposed.

A general advantage of the present invention is that it adds intelligence to the preset store and recall operation in radio head units.

Another more specific advantage is that the radio is able to sense the country in which it is located, and, in response thereto, select an appropriate set of frequencies to assign to the preset pushbuttons.

Yet another advantage is that other vehicle electronics may be automatically modified according to the country in which the vehicle is located, as determined by the vehicle radio.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a diagram illustrating the concept of multi-level planes of radios presets that is supported by the dynamic country determination method of the present invention;

FIG. 2 is a diagram illustrating mapping between frequency learn memory and program identification learn memory according to one embodiment of the present invention;

FIG. 3 is a block diagram illustrating one embodiment of a radio system of the present invention;

FIG. 4a is a first portion of a flow chart of one embodiment of a method of the present invention for operating a radio having a plurality of station preset pushbuttons;

FIG. 4b is a second portion of the flow chart of FIG. 4a;

FIG. 5 is a flow chart of another embodiment of a method of the present invention for operating a radio having a plurality of station preset pushbuttons;

FIG. 6 is a flow chart of yet another embodiment of a method of the present invention for operating a radio having a plurality of station preset pushbuttons; and

FIG. 7 is a flow chart of one embodiment of a method of the present invention for operating electronics in a vehicle having a radio.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

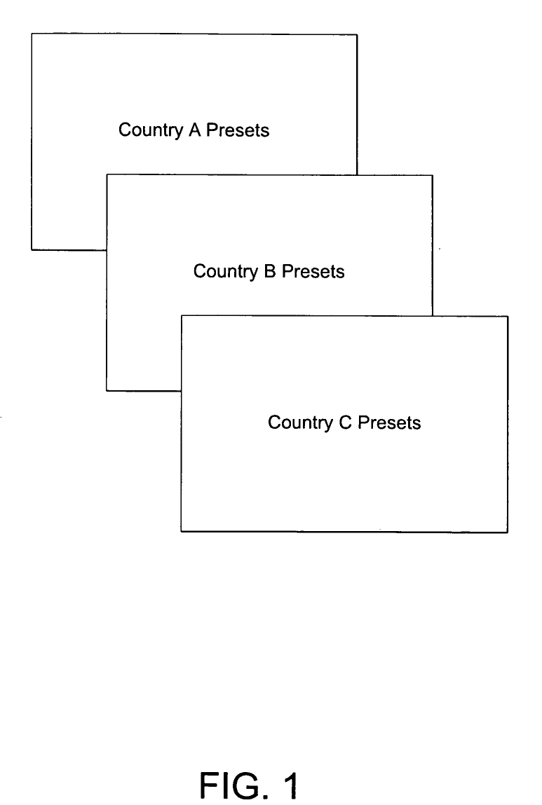

Referring now to the drawings, and particularly to FIG. 1, there is shown a diagram illustrating the concept of multi-level planes of radios presets that is supported by the dynamic country determination method of the present invention. As shown in FIG. 1, multilevel presets are provided per country, and the presets may be stored in non-volatile memory. Each level of presets may include a respective group of frequencies that may be assigned to the preset pushbuttons.

The present invention may enable either a single tuner or dual tuner radio head to intelligently determine the country in which it is situated. This provides the user more flexibility in preset storage and simplifies the preset recall navigation feature.

Assume the scenario of a driver who stores presets in Germany then drives to the United Kingdom. Further assume that the driver performs a preset recall in the U.K. The radio intelligently recognizes that the car is no longer in Germany and informs the user that he is now free to use a new level plane of presets for this new country. The driver can then store his favorite stations in the U.K. as the currently functioning presets. If the user drives back to Germany, the radio will then intelligently activate the appropriate plane of presets associated with Germany for operation by the user.

In European countries, the Radio Data System (RDS) convention is used. RDS is a system wherein radio stations are identified by a Program Identification (ID) code, also referred to as a PI code. The Program ID code is a sixteen-bit word where the most significant nibble identifies the country code.

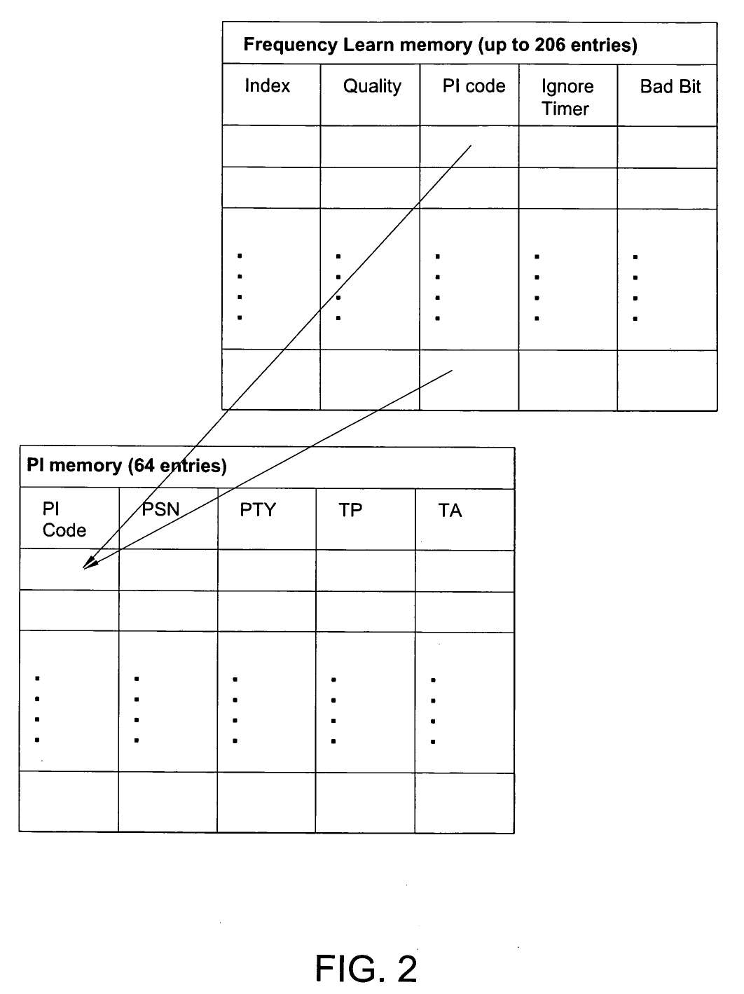

Radios supporting RDS require the Frequency Learn Memory and PI Learn Memory for use in Alternate Frequency Switching and Traffic Announcement, which are usual features supported in radio head units intended for the European market. FIG. 2 illustrates mapping between frequency learn memory and program identification learn memory. Because the European Union (EU) region contains the frequency range from 87.5 to 108 MHz with 100 kHz frequency steps, there are 206 stations in the EU band. The Frequency Learn Memory thus has 206 entries. Because Alternate Frequency Switching, wherein one program station characterized by a Program ID code is transmitted in many frequencies, is used in Europe, there exists a many-to-one mapping (FIG. 2) from frequency learn memory to PI learn memory. In one embodiment, the present invention implements a PI Learn Memory (Program ID Learn Memory) with sixty-four entries.

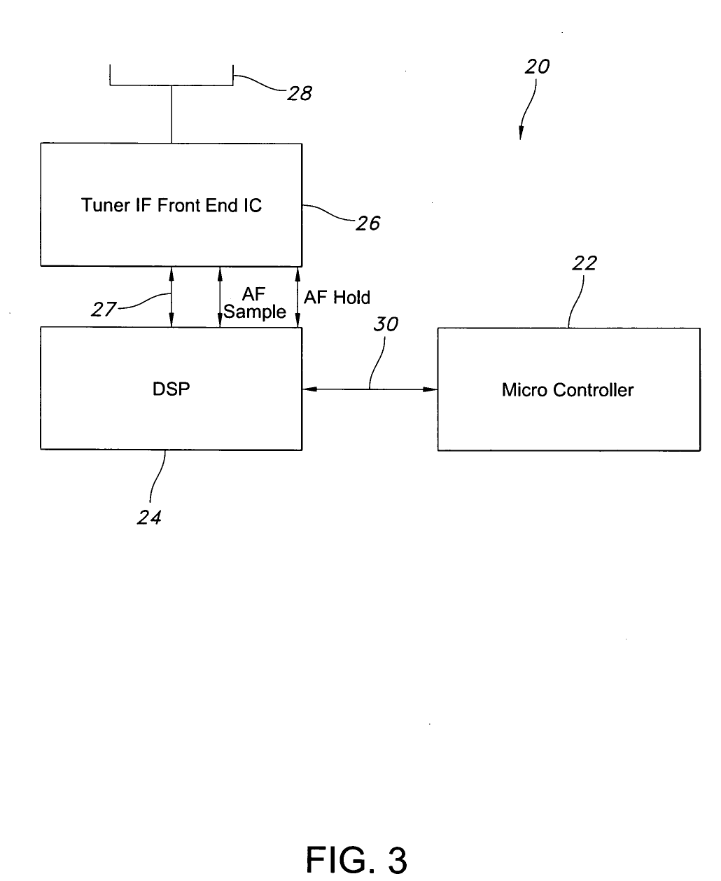

A radio system 20 (FIG. 3) of the present invention may include a microcontroller 22 that may be used to process user input. A digital signal processor (DSP) 24 may be used to provide audio demodulation of the air-borne IF input signal. DSP 24 may also be used to provide quality information parameters to the main microcontroller 22 via a serial communication protocol such as I2C. The quality information parameters may include multipath, adjacent channel noise, and field strength. DSP 24 may rely on a Tuner IC 26 to perform the front end RF demodulation and the gain control. Tuner IC 26 may also output the Intermediate Frequency to DSP 24 where the Intermediate Frequency may be demodulated and processed. Tuner IC 26 may further provide a gain to the IF (Intermediate Frequency) of up to 6 dBuV prior to forwarding the signal to DSP 24. This gain in particular may assist in low sensitivity areas where RDS synchronization is not easily achievable.

DSP 24 may also perform RDS decoding. Each time a valid RDS data packet is available an interrupt is triggered to main microcontroller 22 which then uses the I2C line to acquire the data. Communication between Tuner IC 26 and DSP 24, as indicated at 27, may be via a serial communication protocol such as I2C, which may operate at 400 kbps.

An antenna system 28 may be communicatively coupled to Tuner IC 26. Antenna system 28 may be in the form of a passive mast, or an active mast of phase diversity, for example.

DSP 24 may provide signal quality parameterization of demodulated tuner audio and may make it available to microcontroller 22 via a serial bus 30. In one embodiment, serial communication bus 30 is in the form of a 350 kbps high speed I2C.

The signal parameterization may include field strength, multipath and ultrasonic noise. Field strength may give an indication of signal reception and may help determine whether the radio station has good signal coverage in the vicinity of the user. This field strength quality parameter may be applicable for both AM and FM modulation signal reception.

Although the signal can have high field strength, it can be subject to reflections which can arise from trees and tall building which reflect/deflect the signal. The multipath parameter may enable the level of multipath to be ascertained, and may affect reception quality. The multipath quality parameter may be applicable for both AM and FM modulation signal reception.

Many times stations can overmodulate their signal leading to adjacent channel interference. For example, in the U.S., FM frequencies are spaced apart 200 kHz. Adjacent channel interference can lead to ultrasonic noise in cases where a neighboring station that is next to a currently listened-to station has a high field strength. The high field strength may result in the neighbor station's spectrum overlapping with that of the currently listened-to station, thereby causing audio distortion. Ultrasonic noise may typically be detected by the DSP if the DSP detects harmonics past the 150 kHz band after IF demodulation.

The present invention may operate in a multithreaded system within the software architecture. The tuner application may run on a tuner thread on the main controller.

Every time there is an RDS interrupt, the interrupt service routine may post a message to the tuner thread. Upon receipt of the message, the tuner thread may acquire the data from DSP 24 via I2C link 30 between microcontroller 22 and DSP 24.

The methods of the present invention may be implemented in either a single tuner or dual tuner environment. In a single tuner radio, the main tuner is typically involved in scanning the FM band and updating the frequency learn memory and PI learn memory when in non-tuner source (e.g., when the user is in CD source). The bandscan means that the tuner will switch from one frequency to another and stay in each frequency for approximately 100 milliseconds to acquire signal parameterization data. The scan involves acquiring the signal parameterization of the frequencies and their associated fieldstrength, multipath, and adjacent channel noise, which is converted into a quality value based on a quality table.

The signals that are above a certain quality threshold may be marked by a bit so that as part of the band scan process the microcontroller tunes to these stations and stays on them for about 1.5 seconds to acquire the PI code. The Program Identification (PI) and Program station name scan may be continuous, and each new piece of information that is received may be updated onto the Frequency Learn memory and the PI Learn Memory.

The methods of the present invention may also be implemented in a dual tuner environment. In a dual tuner radio head unit, the main tuner is typically associated with the tune operation for the currently listened-to station while the subtuner is engaged in continuously updating the Frequency Learn Memory and the PI Learn Memory.

The bandscan means that the tuner will switch from one frequency to another and stay in each frequency for approximately 100 milliseconds to acquire signal parameterization data. The scan involves acquiring the signal parameterization of the frequencies and their associated fieldstrength, multipath, and adjacent channel noise, which is converted into a quality value based on a quality table.

The signals that are above a certain quality threshold may be marked by a bit so that as part of the band scan process the microcontroller tunes to these stations and stays on them for about 1.5 seconds to acquire the PI code. The Program Identification (PI) and Program station name scan may be continuous, and each new piece of information that is received may be updated onto the Frequency Learn memory and the PI Learn Memory.

In one embodiment of the algorithm of the present invention, after each fifteen minute time interval, the tuner thread copies up to fifty of the strongest stations from the frequency learn memory into a station list buffer. Fifteen minutes is a time period associated with the hysteresis time, and this time period can be calibrated within the scope of the present invention. Only RDS stations that are above the signal threshold criteria may be allowed to be copied into the station list. The copy involves the stations with PI code information embedded with each station.

The information that is stored about each station may include the field strength of the particular station; the PI code; and the Extended Country Code (ECC), which may make the PI country nibble unique. An ECC and PI mapping may be provided for European countries.

The copying of stations into the station list may occur under two possible scenarios, subtractive update and additive update. Subtractive update may occur in cases where the radio is in a strong signal area where there are more than four stations. This threshold number of four stations may be calibratable. If there are more than four stations, the previous station list entries may be completely cleared and updated with new found entries.

Additive update may occur in cases where the radio is in a weak signal area where there are four or a fewer number of stations. Again, this threshold number of four stations may be calibratable. This scenario may typically arise if the vehicle is in a tunnel or parking garage (i.e., underground), for instance, where signal reception is typically poor. Additive update may differ from the subtractive update in that the previous entries are not cleared and the new entries found are simply added to the list if there is space left within the fifty entries.

The algorithm of the present invention may take the strongest stations that meet the threshold criteria and may sort the stations based on the strongest country. This may be achieved by performing a summation of the field strength per country and determining the strongest country near which the car is situated. The country may be identified by the most significant nibble of the PI code and the extended country code. The strongest country may be determined by performing a check of the number of stations with the same PI country nibble and the same ECC code and then deciding which country has the stations that are being received in the strongest fashion based on their combined field strength value. The country may be identified within the most significant nibble within the PI Code and same ECC code.

Several different situations can arise. First, there can be one strongest country that dominates the Frequency Learn memory with both sum total of field strength and total number of stations for that country. The domination of one country may be based upon a calibratable number of stations which represents the difference between the strongest country and its nearest neighbor country.

In a second situation, two or more countries can potentially have the same field strength total and/or the same number of stations. This can arise if the car is on the border between two or more different countries in Europe.

In a third situation, a country has high field strength overall but a lesser number of stations compared with other countries in the Station List Buffer. In a fourth situation, no stations meet the threshold setting and thus there exists no station information for the algorithm to process.

In the first situation above, the algorithm may automatically inform the radio head unit of the country in which the car is presently situated. The radio may then appropriately inform the Human Machine Interface (HMI) manager to let the user choose an option of reverting to the preset plane associated with the newly detected country. If it is a new country, the new plane may be available for user preset store and recall operation. If the current user preset country plane is the same as the strongest country detected, then there is no operation. If the driver travels to a number of countries that is greater than the number of supported planes of presets, and all the planes of presets are consequently filled up, then the driver may be given the option to override one level plane of presets with a plane of presets associated with the current country. If the car detects that the radio is in the vicinity of a certain country, then the radio may automatically bring up a new plane of presets associated with that country and delete a plane of presets associated with a more distant country, thereby avoiding requiring the user to choose the country. In order to accomplish this, the radio may include a database indicating distances between countries.

In the second and third situations above, the algorithm may automatically inform the radio head unit of the country in which the car is presently situated. The radio may then appropriately inform the HMI manager to let the user choose an option of reverting to the preset planes associated with the newly detected countries. The user thus has an option to make the choice of country. Depending upon user preference, the appropriate preset plane may be automatically implemented.

In the fourth situation above, the algorithm does not execute and no operation is performed. This can arise in cases where there is no valid RDS station in the vicinity of the car that meets the level threshold criteria. The fourth situation can also arise in cases wherein the antenna is disconnected.

In one embodiment, each plane of presets when used is associated with a country nibble and ECC. Each plane of presets may be associated with a respective country. However, it is possible within the scope of the invention for a plane of presets to be associated with a particular region of a country, or for a plane of presets to include stations from more than one country.

The present invention provides a cost effective solution for low cost radios without having to utilize GPS technology. The present invention provides a paradigm shift in preset store and recall operation which enhances the overall user experience and makes it an intelligent process.

The present invention solves the problem of there existing only one level plane of presets and, since the radio is not able to recognize the country in which it is located, the driver has to share his allocated presets among all the countries he visits, which requires the driver to delete and add presets as necessary.

The present invention has been described herein as being addressed to dynamic presets offerings. However, the country determination logic of the present invention may also be applied to non-preset vehicle functions. As a first example, country determination logic may be used in dynamic language selection for car radios. Car manufacturers typically ship the cars to different dealerships in the European continent and need to calibrate the language settings for the display, such as selecting English language font or Russian language font, prior to selling the vehicles. The country determination logic of the present invention may be used to perform such language calibration automatically.

As a second example, country determination logic may be used in speech recognition to dynamically load the proper speech recognition grammar file to match the language (e.g., English, French, etc.) spoken in the country in which the car is presently located.

As a third example, country determination logic may be used in dynamic time synchronization. The information regarding the country in which the car is presently situated may be used to increase the accuracy of the time synchronization.

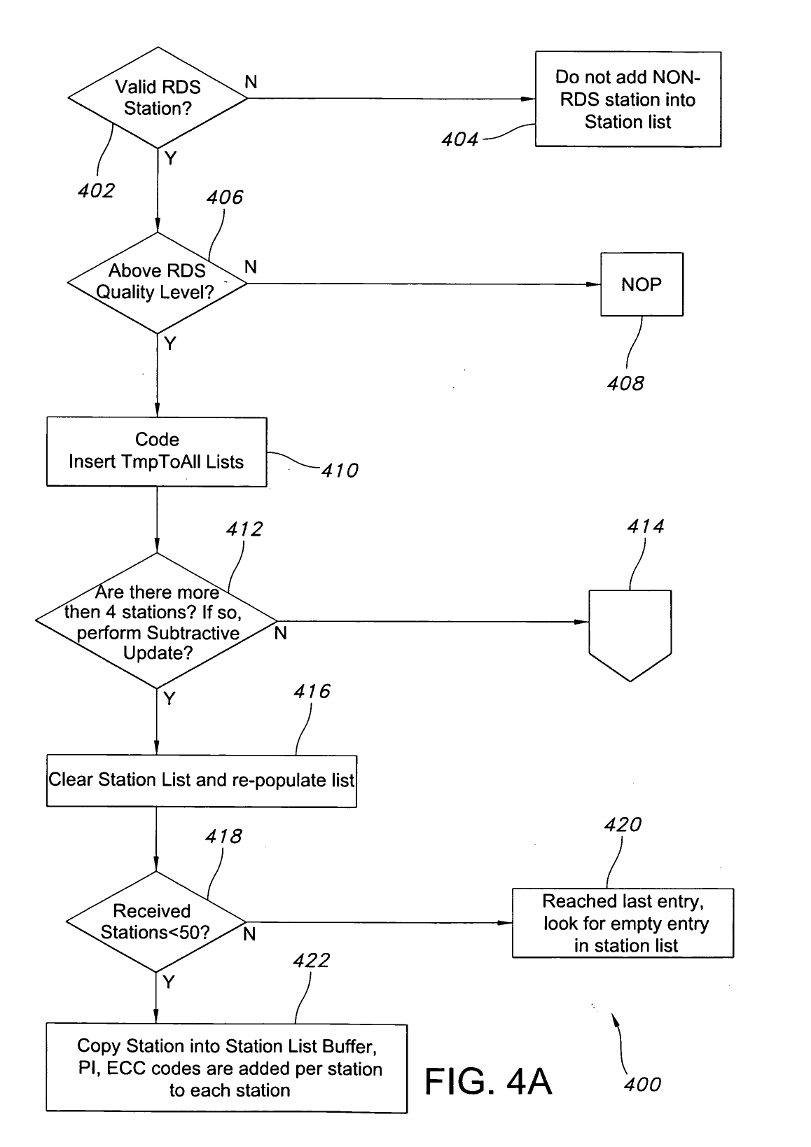

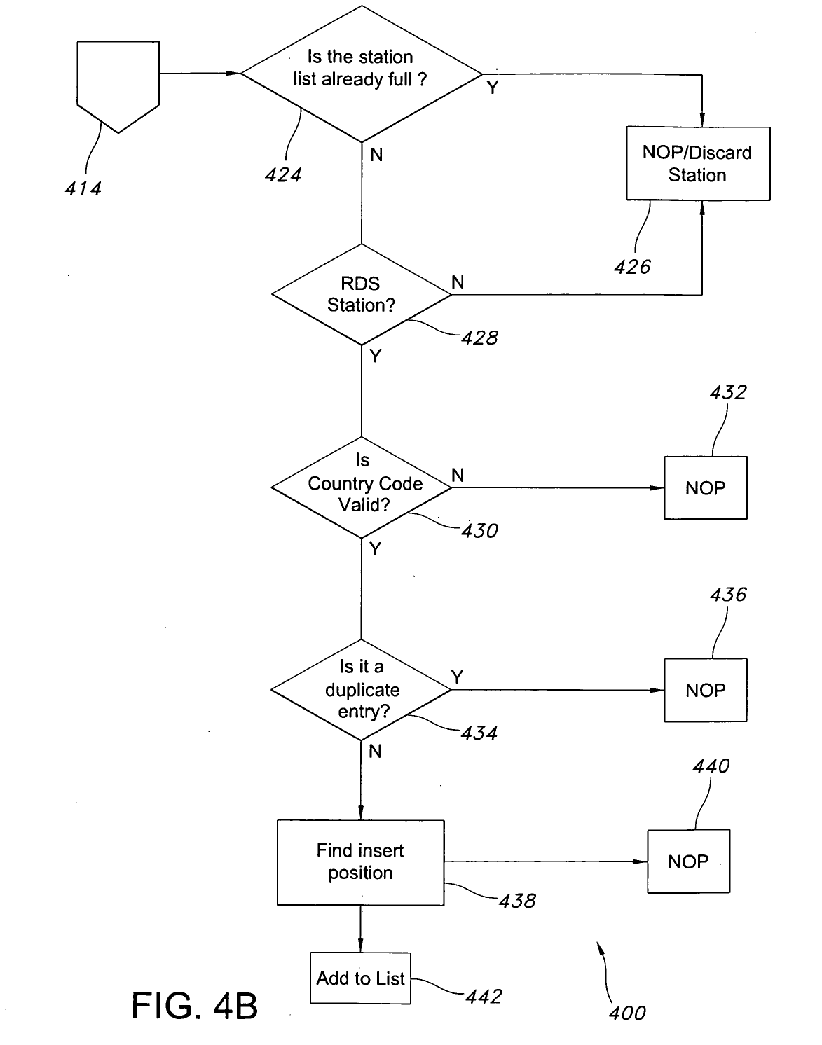

One embodiment of a method 400 of the present invention for operating a radio having a plurality of station preset pushbuttons is illustrated in FIGS. 4a and 4b. Specifically, method 400 may be for copying entries from Frequency Learn Memory and PI Learn Memory to Station List Buffer. In a first step 402, it is determined whether a station is a valid RDS station. If not, as determined by the station's field strength being below a threshold value, then the non-RDS station is not added into the Station List Buffer (step 404). However, if the station's field strength is at least as high as a threshold value, then it is determined in step 406 whether the signal has a quality (e.g., field strength, multipath, ultrasonic noise) that is above a level associated with RDS. If the signal is not above the RDS quality level, then no operation is performed (step 408). If, however, the signal is above the RDS quality level, then operation proceeds to step 410, wherein the station is added or inserted into a TmpToAll List, which is a guard function to check for an illegal country code.

In a next step 412, it is determined whether there are more than four stations identified that meet the quality criteria. If not, then additive update is performed (step 414), which is described in greater detail below with reference to FIG. 4b. If, however, there are more than four stations meeting the quality criteria, then subtractive update is performed, and operation proceeds to step 416 wherein the Station List is cleared and the list is re-populated.

Operation continues to step 418 where it is determined whether the number of stations thus far received in the Station List Buffer is less than fifty. If not, then it is known that the last entry of the Station List Buffer has been reached, and an empty entry in the station list is searched for (step 420). If, however, the number of stations thus far received in the Station List Buffer is less than fifty, then the current station is copied into the Station List Buffer, and PI, ECC codes are added per station to each station (step 422). The above process may be repeated for each subsequent station.

The performance of additive update (step 414) is detailed in FIG. 4b. In a first step of additive update (step 424), it is determined whether the station list is already full. If so, then no operation is taken and/or the current station is discarded (step 426). If, however, the station list is not already full (i.e., there is still space in the list), then it is determined in step 428 whether the current station is an RDS station. If the current station is a non-RDS station, then operation proceeds to step 426 wherein no operation is taken and/or the current station is discarded. If, however, it is determined in step 428 that the current station is an RDS station, then it is determined in step 430 whether the country code of the station is valid.

Per the RDS standard, the country code is only from hexadecimal numerals 1 to F. The validity of the country code is checked in step 430 in case the DSP returns an invalid country code. An invalid country code may be returned in case of poor signal conditions in which, even with cyclic redundancy check (CRC) error correction, invalid data can get through undetected. If it is found in step 430 that the country code is invalid, then no operation is performed (step 432). On the other hand, if it is determined in step 430 that the country code is valid, then it is determined in step 434 whether the station is a duplicate entry. If the station is indeed a duplicate entry, then no operation is performed (step 436). If, however, the station is not a duplicate entry, then operation proceeds to step 438 wherein a position in the station list is found to insert the current station. If the current station is not a valid entry and/or there is no space available in the station list, then no operation is performed (step 440). If, however, an insert position is found in the station list in step 438, then the station is inserted into that position (step 442).

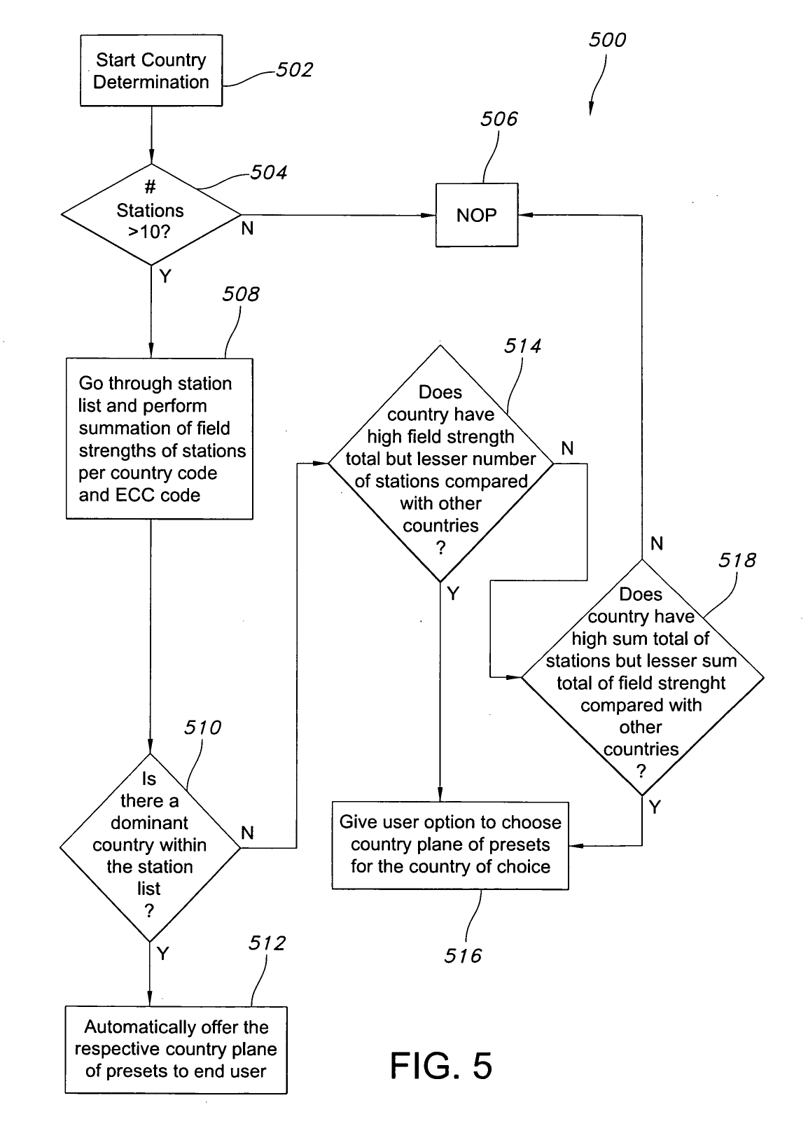

A method 500 of the present invention for presenting a country plane of presets to the end user is illustrated in FIG. 5. In a first step 502, the process of determining which country the vehicle is presently situated in is commenced. In one embodiment, the Start Country Determination from the Station List occurs once every fifteen minutes, although this may be a calibratable time period. In a next step 504, it is decided whether the number of available stations is greater than ten, which may be a calibratable number. If the number of stations is not greater than ten, then no operation is performed (step 506). If, however, it is determined in step 504 that the number of stations is indeed greater than ten, then in step 508 the station list is gone through and a summation of field strengths of stations per country code and ECC code is performed.

In a next step 510, it is determined whether there is a dominant country within the station list. That is, it is determined whether there is a country that has a maximum number of stations all with thresholds above the RDS field strength level AND that has a maximum sum total of field strength among all countries in the station list buffer. If there is such a dominant country, then the corresponding country plane of presets may be automatically offered to the end user (step 512). However, if there is no such dominant country, then it is determined in step 514 whether there is a country having a high field strength total but a lesser number of stations as compared with other countries. If there is such a country, then in step 516 the user is given an option to choose a country plane of presets for the country of choice. If there is not such a country, then it is determined in step 518 whether there is a country having a high sum total of stations but a lesser sum total of field strength as compared with other countries. If there is not such a country, then there is no operation (step 506). However, if there is such a country, then operation proceeds to step 516.

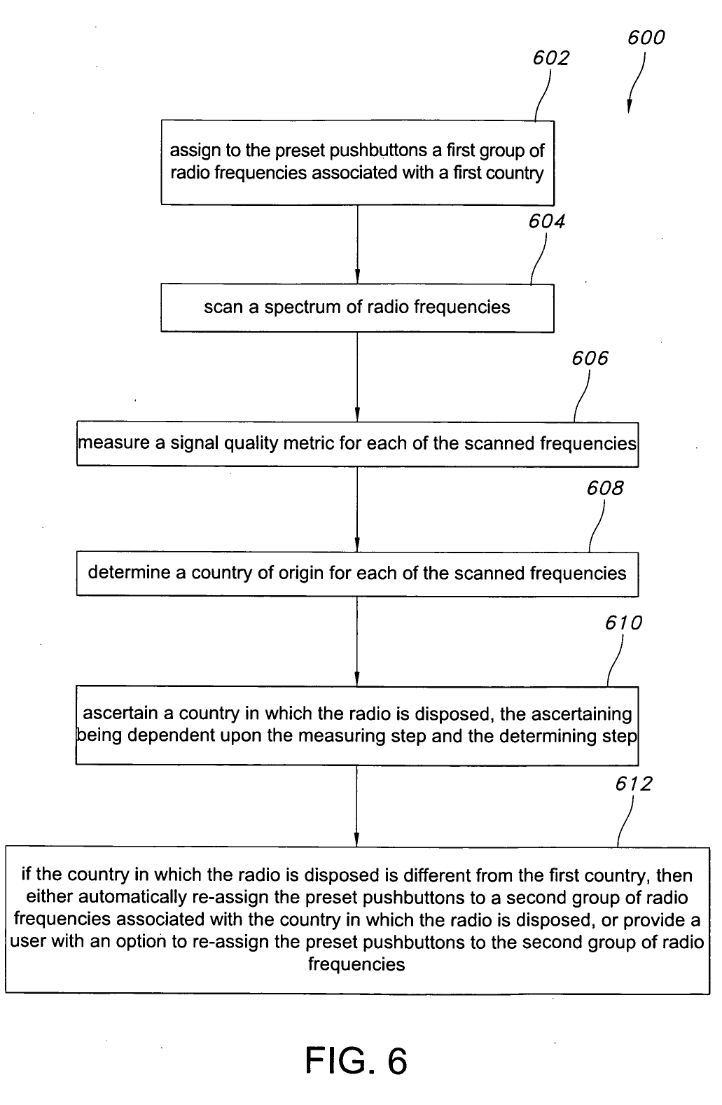

One embodiment of a method 600 of the present invention for operating a radio having a plurality of station preset pushbuttons is illustrated in FIG. 6. In a first step 602, a first group of radio frequencies associated with a first country is assigned to the preset pushbuttons. For example, a group of radio frequencies represented by one of Country A Presets, Country B Presets and Country C Presets (FIG. 1) may be assigned to the pushbuttons on the faceplate of a car radio.

In a next step 604, a spectrum of radio frequencies is scanned. In the example discussed hereinabove, 206 station frequencies in the EU FM band may be scanned.

In step 606, a signal quality metric is measured for each of the scanned frequencies. For example, a signal quality metric such as field strength, multipath or ultrasonic noise may be measured for each of the 206 station frequencies in the EU FM band.

Next, in step 608, a country of origin is determined for each of the scanned frequencies. In one embodiment, the country of origin is determined by examining the most significant nibble of the PI Code and the ECC Code.

In a next step 610, a country in which the radio is disposed is ascertained, the ascertaining being dependent upon the measuring step and the determining step. That is, the country of origin of the highest quality signals may be determined based on the signal quality measurements and the country of origin determinations. This country of origin of the highest quality signals may be assumed to be the country in which the radio is disposed.

Lastly, in step 612, if the country in which the radio is disposed is different from the first country, then either the preset pushbuttons are automatically re-assigned to a second group of radio frequencies associated with the country in which the radio is disposed, or a user is provided with an option to re-assign the preset pushbuttons to the second group of radio frequencies. For instance, if the radio were originally in Germany, with German frequencies being assigned to the preset pushbuttons, and then the radio moved to the U.K., as ascertained by the radio, then either the preset pushbuttons may automatically be re-assigned U.K. frequencies or the user may be given an option to re-assign the preset pushbuttons U.K. frequencies.

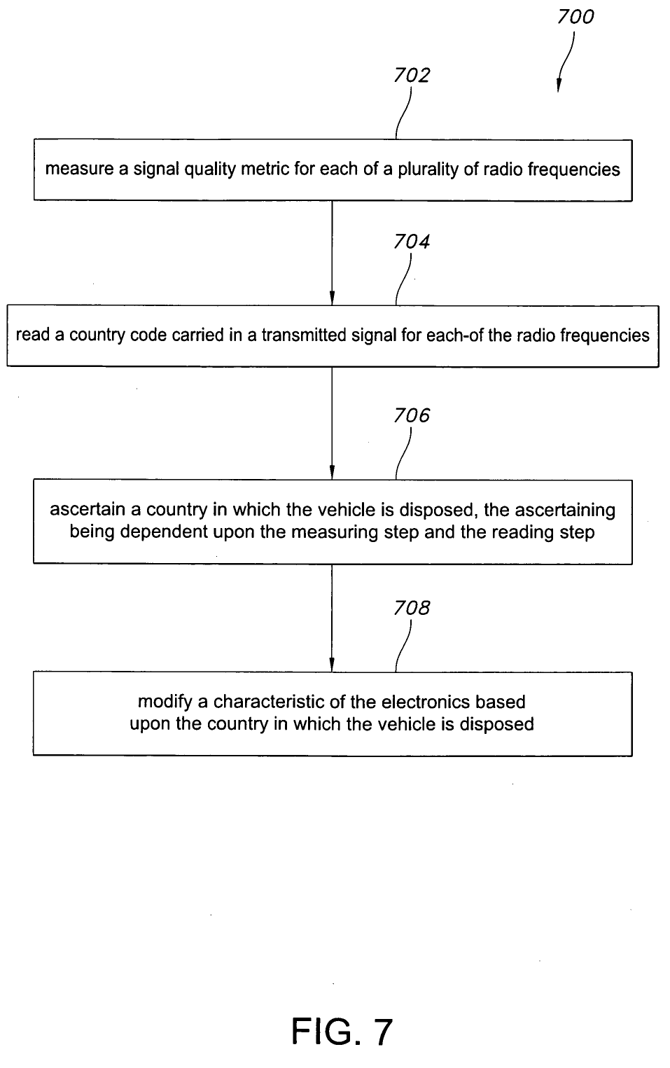

One embodiment of a method 700 of the present invention for operating electronics in a vehicle having a radio is illustrated in FIG. 7. In a first step 702, a signal quality metric is measured for each of a plurality of radio frequencies. For example, a signal quality metric such as field strength, multipath or ultrasonic noise may be measured for each of the 206 station frequencies in the EU FM band.

Next, in step 704, a country code carried in a transmitted signal is read for each of the radio frequencies. In one embodiment, a country code is carried in the most significant nibble of a PI Code and an ECC Code of a signal transmitted at each of the radio frequencies.

In a next step 706, a country in which the vehicle is disposed is ascertained, the ascertaining being dependent upon the measuring step and the reading step. That is, the country code associated with the highest quality signals may be ascertained based on the signal quality measurements and the reading of the signals' country codes. This country code of the highest quality signals may be assumed to specify the country in which the vehicle is disposed.

In a final step 708, a characteristic of the electronics is modified based upon the country in which the vehicle is disposed. In the exemplary embodiment discussed hereinabove, the frequencies assigned to the radio preset pushbuttons are modified based upon the country in which the vehicle is disposed. However, it is also possible to modify another characteristic of the electronics, such as the dynamic language selection, the speech recognition, and/or the dynamic time synchronization, based upon the country in which the vehicle is disposed.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of operating a radio having a plurality of station preset pushbuttons, said method comprising the steps of:
assigning to the preset pushbuttons a first group of radio frequencies associated with a first country;
scanning a spectrum of radio frequencies;
measuring a signal quality metric for each of the scanned frequencies;
determining a country of origin for each of the scanned frequencies;
ascertaining a country in which the radio is disposed, the ascertaining being dependent upon the measuring step and the determining step; and
if the country in which the radio is disposed is different from the first country, then one of:
automatically re-assigning the preset pushbuttons to a second group of radio frequencies associated with the country in which the radio is disposed; and
providing a user with an option to re-assign the preset pushbuttons to the second group of radio frequencies.

2. The method of claim 1 wherein the signal quality metric comprises field strength.

3. The method of claim 2 wherein the determining step includes reading a country code of a Radio Data System program identification for each of the scanned frequencies.

4. The method of claim 1 wherein the ascertaining step comprises determining a country of origin for a set of the scanned frequencies having best signal quality metrics.

5. The method of claim 1 comprising the further step of storing a plurality of groups of radio frequencies in a memory device, each of the groups being associated with a respective country.

6. The method of claim 5 comprising the further step of retrieving the second group of frequencies from the memory device.

7. The method of claim 1 wherein the signal quality metric is dependent upon at least one of field strength, level of multipath, and ultrasonic noise.

8. A method of operating electronics in a vehicle having a radio, said method comprising the steps of:
measuring a signal quality metric for each of a plurality of radio frequencies;
reading a country code carried in a transmitted signal for each of the radio frequencies;
ascertaining a country in which the vehicle is disposed, the ascertaining being dependent upon the measuring step and the reading step; and
modifying a characteristic of the electronics based upon the country in which the vehicle is disposed.

9. The method of claim 8 comprising the further step, after the ascertaining step, of providing a user with an option to inhibit the modifying step.

10. The method of claim 8 wherein the characteristic comprises a group of preset radio frequencies.

11. The method of claim 8 wherein the characteristic comprises a language selection for the radio.

12. The method of claim 8 wherein the characteristic comprises a speech recognition parameter.

13. The method of claim 8 wherein the characteristic comprises a time-of-day setting.

14. The method of claim 8 wherein the signal quality metric is dependent upon at least one of field strength, level of multipath, and ultrasonic noise.

15. A method of operating a radio having a plurality of station preset pushbuttons, said method comprising the steps of:
measuring a signal quality metric for each of a plurality of frequencies;
reading a country code of a Radio Data System program identification for each of the frequencies;
ascertaining a country in which the radio is disposed, the ascertaining being dependent upon the measuring step and the reading step; and
assigning the preset pushbuttons to a group of radio frequencies associated with the country in which the radio is disposed.

16. The method of claim 15 wherein the signal quality metric comprises field strength.

17. The method of claim 15 wherein the ascertaining step comprises determining a country of origin for a set of the frequencies having best signal quality metrics.

18. The method of claim 15 comprising the further step of storing a plurality of groups of radio frequencies in a memory device, each of the groups being associated with a respective country.

19. The method of claim 18 wherein the group of radio frequencies associated with the country in which the radio is disposed is retrieved from the memory device.

20. The method of claim 15 wherein the signal quality metric is dependent upon at least one of field strength, level of multipath, and ultrasonic noise.
